(19) United States
(12) Patent Application Publication
(10) Pub. No.: US 2008/0174448 A1
(43) Pub. Date: Jul. 24, 2008

(54) Modular Controller

(76) Inventor: Edison Hudson, Chapel Hill, NC (US)

Correspondence Address: O''Brien Jones, PLLC (w/iRobot Corp.), 8200 Greensboro Drive, Suite 1020A, McLean, VA, 22102, US

(21) Appl. No.: 11/933,308

(22) Filed: Oct. 31, 2007

Related U.S. Application Data
(60) Provisional application No. 60/863,787, filed on Oct. 31, 2006.

(51) Int. Cl. G05B 11/01; G05B 19/04

(52) U.S. Cl. 340/825.22

(57) ABSTRACT

A portable network for connecting and utilizing functional modules to create an upgradable and reconfigurable device for controlling a remote vehicle. The portable network connects a processor configured to control a remote vehicle with recesses configured to receive functional modules.

### PRIORITY

This application claims priority to U.S. Provisional Patent Application No. 60/863,787, entitled Modular Design for Controller, filed Oct. 31, 2006, the entire content of which is incorporated by reference herein.

### DESCRIPTION

1. Field

The present invention relates generally to a modular portable controller, and more particularly a modular portable controller that is durable, upgradable, and reconfigurable. The present invention also relates to a portable network for connecting and utilizing functional modules to create an upgradable and reconfigurable controller.

2. Introduction

The capability of technology is increasing rapidly, along with the expectations of users who rely on that technology. As a result, products employing even state-of-the-art technology can quickly become obsolete and require replacement. In addition, many products are built for a single application, having limited or no usefulness outside of the application for which they are specifically designed. The requirement for obtaining and perhaps carrying multiple products for multiple applications, and purchasing new products as technological advances become available can be costly, time consuming, and undesirable in other ways.

### SUMMARY

The present invention may address one or more of the above-mentioned issues. Other features and/or advantages may become apparent from the description which follows.

Certain embodiments of the invention provide a portable network for connecting and utilizing functional modules to create an upgradable and reconfigurable device for controlling a remote vehicle. The portable network connects a processor configured to control a remote vehicle with recesses configured to receive functional modules.

Certain embodiments of the invention alternatively or additionally provide a portable modular system comprising a frame including a processor, a network backplane, a display, one or more input devices, and recesses configured to receive functional modules. A communication device is included in the frame or connectable to the frame. The network backplane connects the processor and the functional modules allowing at least one of the processor and the functional modules to control a remote vehicle via the display, the input devices, and the communication device.

Certain embodiments of the invention alternatively or additionally provide a portable device for controlling a remote vehicle. The device comprises input devices configured to allow the user to input controls for the remote vehicle, a display configured to display data regarding the remote vehicle to the user, a communication device for exchanging data between the user and the remote vehicle, an onboard processor configured for controlling the remote vehicle, a network backplane, and recesses configured to receive functional modules that allow upgrading and reconfiguring of the device. Functional modules inserted into the recesses are connected to at least one other element of the frame via the network backplane.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

Features and advantages of the claimed subject matter will be apparent from the following detailed description of embodiments consistent therewith, which description should be considered with reference to the accompanying, wherein:

FIG. 1 illustrates a front perspective view of an exemplary implementation of a modular controller in accordance with the present teachings;

FIG. 2 is a rear exploded view of the exemplary embodiment of FIG. 1;

FIG. 3 is a rear view of the exemplary embodiment of FIG. 1;

FIG. 4 is a bottom view of the exemplary embodiment of FIG. 1;

FIG. 5 is a front view of another exemplary implementation of a modular controller in accordance with the present teachings;

FIG. 6 illustrates a block architecture of an exemplary embodiment of a controller frame for a system of the present teachings;

FIG. 7 illustrates an exemplary embodiment of external interactions that the onboard processor can have in accordance with the present teachings; and

FIG. 8 illustrates an exemplary embodiment of internal interactions that the onboard processor can have in accordance with the present teachings.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION OF VARIOUS EMBODIMENTS

Reference will now be made to various embodiments, examples of which are illustrated in the accompanying drawings. However, these various exemplary embodiments are not intended to limit the disclosure. To the contrary, the disclosure is intended to cover alternatives, modifications, and equivalents.

The present teachings contemplate a flexible and adaptable controller that can accommodate near-term user requirements, including control of one or more remote vehicles, while having a modularity that facilitates upgrades, replacement of obsolete or non-working modules, and reconfiguration for a variety of applications. In accordance with certain embodiments of the present teachings, the controller can incorporate and leverage technological change over an extended period of time, including improvements and changing standards affecting processors, storage, communication, etc. In addition, certain embodiments of the present teachings accommodate compliance with competing power and performance demands of changing requirements.

The present teachings contemplate the controller being a hand-held or portable network (e.g., an Ethernet backplane) that can accommodate more than one enclave for different classes of information. In certain embodiments of the present teachings, the frame or base of the controller is a host for functional modules and is essentially a network frame rather than a computer, where one of the functional modules can include a processor for controlling a remote vehicle and not all of the modules may be needed for the controller to perform its intended functions.

In certain embodiments, the present teachings additionally contemplate the ability to segregate processing, communication, and storage of different classifications of information, as well as the ability for different functional modules to perform their intended functions even when the controller's full capability is not enabled.

A portable controller in accordance with the present teachings and for use in combat scenarios may perform such functionality as remote vehicle control for one or more remote vehicles of the same or different types, operator training and simulations, unattended munitions control, logistics and maintenance control, tracking, and assistance, control and monitoring of unmanned ground sensors, performance of certain battle command functions such as mission rehearsal and preparations/planning, and even medical diagnostics.

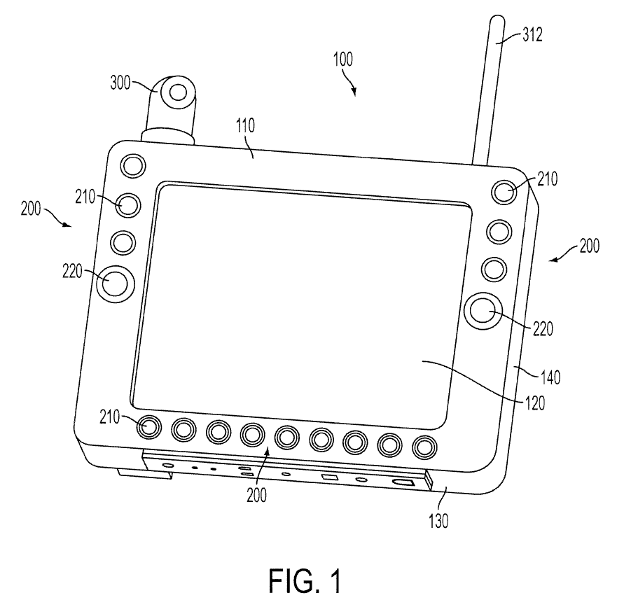

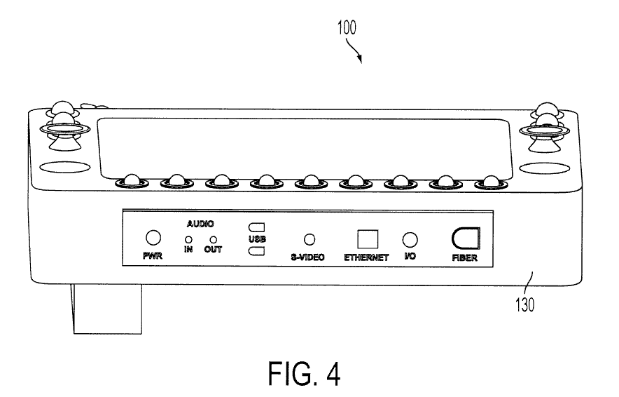

FIGS. 1-4 illustrate and exemplary implementation of a modular controller in accordance with of the present teachings, which includes a base system or frame 100 with a front surface 110 including a display 120 and one or more input devices 200 such as buttons 210 and joysticks or pucks 220. Input devices may also include touchscreen input (not shown) and I/O connectors for example for attachment of a mouse keypad, supplemental hand-held controller, etc. In the exemplary implementation of FIG. 1, the front surface 110 of the base system or frame 100 has a generally rectangular shape, but may alternatively have any suitable shape such as square, oval, etc. The frame 100 also includes a bottom surface 130, side surfaces 140, a top surface 150, and a back surface 160. Input devices 200 need not be limited to the front and bottom surfaces of the frame 100. Indeed, FIG. 4 illustrates an exemplary embodiment of the bottom surface 130 of the controller frame 100 that includes a variety of I/O connectors, for example power, audio, USB, s-video, network connection and fiber optic. The fiber optic input connector can be used, for example, to tether a remote vehicle for controlling the remote vehicle via the controller when RF communication is not available or is not desirable. The overall size of the controller, in accordance with one exemplary implementation of the present invention, can be about 242 mm×326 mm×72 mm.

In certain embodiments of the present teachings, such as the illustrated exemplary implementation, the top surface 150 of the controller frame 100 can include an imager 300 for taking pictures and/or video of the controller's environment. An imager could be use, for example, to record and transmit aspects of the controller's environment that would be of immediate or archival interest. The optional imager 300 can be an upgradable module of the system.

In accordance with certain embodiments of the present invention, the controller frame 100 includes a processor supporting a certain amount of basic functionality, including graphics processing and display, remote vehicle control, and a radio link, as described in more detail below. Limited-mode graphics processing can be implemented as a macro in FPGA, for example supporting low latency video and/or a picture-in-picture overlay to the graphics processor. In such an embodiment, a second processor (or second and third processors, for example when processing and storage are to be segregated in a dual enclave system where each enclave is a separate processor) can provide memory, storage, GPS, etc. The present teachings contemplate using dedicated controllers or processors for certain functionalities, such as a dedicated display controller for example, although having dedicated processors could increase power requirements of the system.

The illustrated exemplary implementation of FIGS. 1-4 also includes a radio module 310 having an antenna 312, wherein the radio module can be installed and removed easily. The radio module 310 can be, for example, a joint tactical radio system (JTRS) or other software-programmable tactical radio that can provide a user with voice, data, and video communications, as well as interoperability and sufficient bandwidth to meet present and perhaps future communications requirements. In certain embodiments of the present teachings, the radio module includes a small form factor radio that can interface using an internet protocol link and operate from 12 vDC. In addition to being software upgradeable, the radio module 310 can also be easily physically replaced for upgrades or if it is not operating properly. In military use, radio module 310 can facilitate receipt of commands by the user, exchange of intelligence and other information, and communication with a remote vehicle to be controlled by the controller. Certain embodiments of the present teachings contemplate the radio having two channels for data transmission segregation.

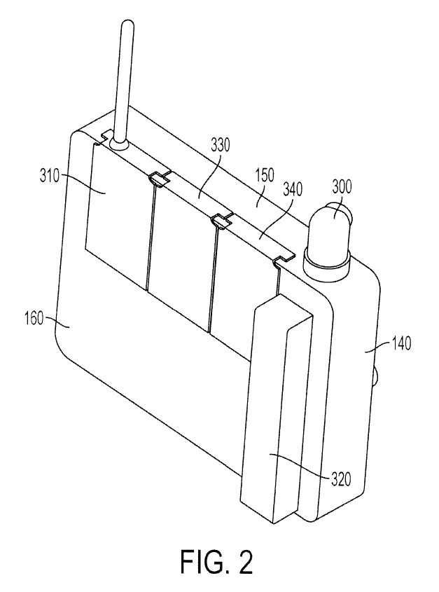

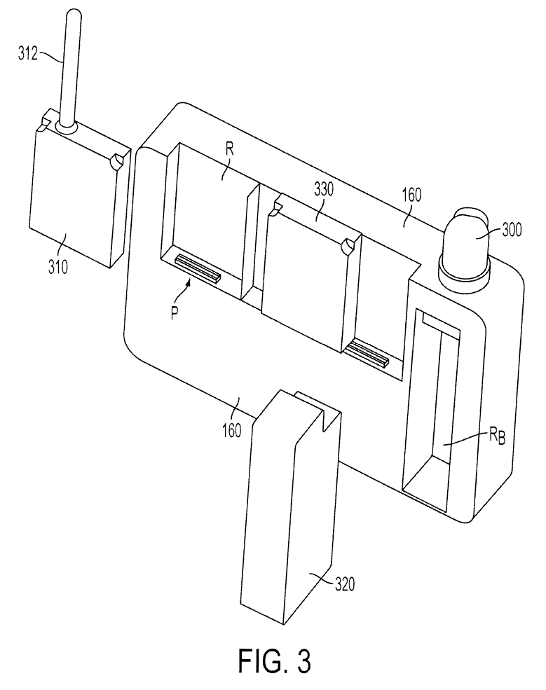

Rear views of the controller frame 100 are shown in FIGS. 2 and 3 and illustrate an embodiment of the system modularity of the present teachings. As shown the rear surface includes recesses R for insertion of various functional modules such as, for example, the above-discussed radio module 310. The functional modules inserted can depend on or dictate the desired functionality of the controller. For example, additional processors having certain desired functionalities can be inserted into the recesses R. The additional processors 330 and 340 can be used, for example, for embedded user training, control of one or more remote vehicles (e.g., unmanned ground vehicles (UGVs) and unmanned air vehicles (UAVs)), unattended munitions control, and control of and data receipt from unmanned ground sensors (UGSs) that provide unmanned networked surveillance for areas of interest. The recesses need not all be filled, and can be filled with other types of functional modules such as memory and storage devices, additional radio modules, etc. Functional module, as used herein is defined as an modular component for insertion into the frame that can perform a function or a part of a function when inserted.

Plug-ins P within the recesses R can include a simple interface between the module and the controller frame that consists of, for example network differential signaling, power for the module, and a digital video bus. Therefore, a plug-in P having only three prongs can be utilized in certain embodiments of the present teachings.

The present teachings contemplate dividing functions performed by the onboard and modular processors of the controller in a variety of ways. For example, functionality such as identification of logistics and maintenance functions can be performed by any processor of the controller, as can the above-mentioned functions. The modularity of the system accommodates fast and efficient next-generation processors via plug-in replacement of computing modules.

Another recess R_{B} can receive a power source 320 such as a swappable battery that meets the requirements of the controller and its intended functions. The recess R_{B} can have any suitable shape that accommodates the desired battery or power source, and can be located at the rear of the controller frame or in another suitable location, such as within the controller frame or along its bottom, for example. The battery can be easily swapped for a newly-charged battery or upgraded as battery abilities increase.

A tension can exist between performance and run-time demands for devices, and achieving desired run-time durations for use with high-powered processors can require battery swapping and frequent upgrades. In certain embodiments of the present teachings, the power source 320 can include an existing battery unit such as a Lithium Ion-based UltraLife UBBL06 (LI-145) military radio battery having an energy storage capacity of about 143 watt hours. However, battery capacities increase frequently and higher storage capacity batteries can easily be accommodated in the controller frame 100, along with fuel cells such as Methanol-H₂O and Boron-Hydride fuel cells. The present teachings contemplate having more than one battery recess R_{B} to facilitate battery swapping while the controller is being used. The present teachings also contemplate utilizing a rechargeable battery, and/or a battery having a quick exchange form factor allowing quick hot swapping of batteries.

Certain embodiments of the present teachings, particularly those contemplating use of the controller for military and industrial tasks, include a ruggedized frame and modules.

In certain embodiments of the present teachings where the controller is used for controlling a remote vehicle, input devices 200, a display 120, and a communication link with the remote vehicle, along with an onboard processor and/or a processor module, facilitate such control. The display can provide the user with video stream from cameras on the remote vehicle that inform the user regarding the remote vehicle's environment. The display can also provide other information regarding the remote vehicle and its environment such as the remote vehicle's battery charge level and diagnostics, the remote vehicle configuration or pose, its orientation, range-finding data, etc. Indeed, for control of more than one remote vehicle, the display can provide such information for each remote vehicle being controlled.

In such embodiments, the input devices can be used to teleoperate certain remote vehicles or activate certain behaviors of remote vehicles. They can also be used to interact with controlled remote vehicles in other ways, including requesting information from the remote vehicles. The joysticks or pucks 220 can be used to drive the remote vehicle and/or control a camera, an arm, or other payload on the remote vehicle that can be similarly manipulated by the user. The input devices may be labeled on the frame itself, or their functionality may be designated on the display screen.

A communication link can be established using any known, suitable communication device that can facilitate exchange of information with the remote vehicle, including via an RF link (e.g., through the RF radio module), or via a physical connection such as a tether.

In certain embodiments of the present teachings, the base system or frame 100 is a laptop- or tablet-sized hand-held controller that uses architecture similar to a blade server concept in that it provides a small, dense, expandable, upgradable, and reconfigurable system. The form of modular computing used can include a “computer-on-module” (COM) standard that can provide a complete computer built on a single circuit board.

In certain embodiments of the present invention local processor modules within the controller are connected using a network such as a gigabit Ethernet, which can provide a simple connection scheme with ample bandwidth for future expansion. As used herein, gigabit Ethernet refers to various technologies for transmitting Ethernet frames at a rate of a gigabit per second, preferably as defined by the IEEE 802.3-2005 standard. Gigabit Ethernet may employ optical fiber, twisted-pair cable, coaxial cable or copper cable. The present teachings contemplate using optical fiber when it is useful to provide enhanced electromagnetic security (because optical fiber produces no electromagnetic emissions).

In certain embodiments of the present teachings, the system can allow the controller to perform certain available functions despite other functionality of the controller being unavailable, in hibernate mode to save battery power, or turned off purposefully to limit user capabilities. For example, the controller may be able to control a remote vehicle even when the unable to send and a receive other communications to and from a remote location (e.g., commands and intelligence), or when all other functionality has been turned off, for example to control a remote vehicle when it is being used for training or is undergoing repair, testing, or maintenance.

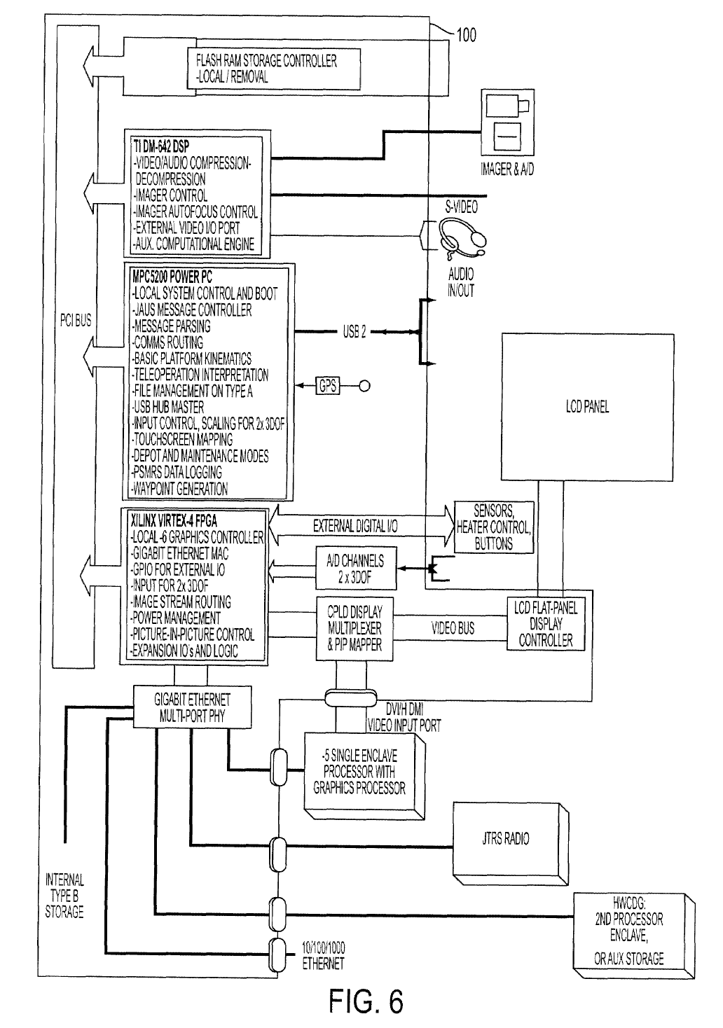

Certain embodiments of the present teachings contemplate utilizing a system level power management that allows processors to be awakened only as their functionality is needed, thus lowering power consumption. For example, in embodiments having more than one processor, such as the onboard processor and a processor module with graphics processing illustrated in FIG. 6, the present teachings contemplate the onboard processor performing low-level functions (e.g., video compression/decompression, protocol handling) that do not need heavy computation loading, and the processor module performing high-level functions. Invoking the high-level functions of the controller and awakening the additional, perhaps more power-hungry processor module can be managed to occur only when such high-level functions are needed.

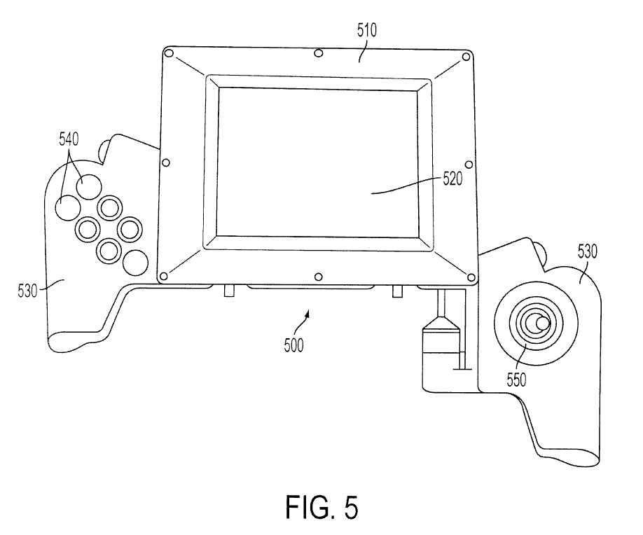

FIG. 5 illustrates another exemplary implementation of a controller 500 in accordance with the present teachings. Only a front surface 510 of the controller is shown, which includes a display 520 and two input portions 530 that include user interface controls such as buttons 540 and joysticks or pucks 550. This exemplary embodiment can include an additional level of modularity by having swappable input portions 530 allowing a certain amount of customization of the type of user input controls available. The controller can otherwise be similar in design to the exemplary embodiment illustrated in FIGS. 1-4, including a network interconnection and swappable modules and battery.

FIG. 6 illustrates a block architecture of an exemplary embodiment of a controller frame for a system of the present teachings. The frame 100 includes resources to perform at least a baseline graphics control function even without availability of additional processor modules (e.g., additional processor modules are not present, are not functioning, or are hibernated). In the illustrated exemplary embodiment, the frame 100 includes a RAM storage controller, a digital signal processor such as a TI DM-652 for video and audio compression and decompression, imager control, imager autofocus control, etc. The imager 300, any optional s-video, and audio can be input through the digital signal processor as illustrated.

In the illustrated exemplary embodiment the controller frame 100 onboard processor can be, for example, an MPC5200 Power PC that can perform such functions as local system control and boot, message controls and message parsing for message passing architecture, communication routing, basic platform kinematics, remote vehicle teleoperation interpretation, file management, USB hub master, input control, touchscreen mapping, depot and maintenance modes for remote vehicle servicing, etc. USB input ports and an optional GPS can be input to the onboard processor.

An FPGA such as a Xilinx Virtex-4 FPGA can also be provided in the controller frame 100 of the illustrated exemplary embodiment. The FPGA can provide local graphics control, network media access control, general-purpose I/O for external I/O input such as joystick input, image stream routing, power management, picture-in-picture control, etc. Inputs to the FPGA can include external digital I/O from such devices as sensors, heater controls, etc., and the FPGA can process input from 3 degree-of-freedom A/D channels (e.g., joysticks or pucks). The FPGA can output via a video bus to an LCD panel, for example through a complex programmable logic device (CPLD) display multiplexer & parallel interface port (PIP) mapper and a LCD panel display controller. The FPGA can provide enhanced functions such as addition of baseline graphics controller functionality that can enable the onboard processor to support basic graphical functions. This can be accomplished, for example, using a macro-cell library for graphics control embedded in the FPGA. Basic graphics controllers for FPGAs are commercially available and can support resolutions of up to 1024 and 256 colors in a small number of logic cells.

By synchronizing the onboard processor and FPGA with the digital signal processor, display of real-time streaming data (e.g., from a remote vehicle being controlled) can be enabled without intervention from an additional processor module. This can allow control of one or more remote vehicles using only the controller frame without additional processor modules.

Certain embodiments of the present teachings contemplate utilizing a modular processor with a graphics processor in one of the frame recesses R, as shown in FIG. 6, which can be capable of bypassing the FPGA graphics processor within the controller frame 100 and performing power graphics generated by its graphics processor. The CPLD display multiplexer and PIP mapper can then act as a cross point switch to map the modular processor with a graphics processor into the LCD panel display controller when the modular processor with a graphics processor is available, functioning, and not hibernated. Thus, the modular processor with a graphics processor becomes the primary display controller. Even when the modular processor with a graphics processor is the primary display controller, the present teachings contemplate reducing latency using the digital signal processor and the FPGA logic to map into a picture-in-picture window that can receive video streams from the decompression process without having to pass through the modular processor with a graphics processor, which may be burdened with other functions.

In accordance with certain embodiments of the present teachings, processor modules, such as for example multi-core processor modules, for insertion into the controller frame include computer-on-module COM modules or COM-Express modules perhaps being depopulated to a certain degree because, for example, certain standard COM module components such as chips for ATA disk control may not be needed when the network (e.g., a gigabit Ethernet backbone) is used for mass transfer (i.e., communication and large file transfers) between subsystems and modules. Certain embodiments of the present teachings contemplate a special enclosure for the COM modules, such as a thermal conduction module having a standard interconnect system for the network. A simple interface between the module and the controller frame can, for example, consist of: network differential signaling (standard twisted-pair signaling); power for the module (nominally 12 vDC); and a digital video bus (e.g., LVDS, HDMI, DVI, or another suitable bus) for a processor module such as that shown in FIG. 6 that includes a graphics processor. Such a simplified scheme can reduce the necessary pin count for connection between the modules and the controller frame and can increase signal integrity. It can additionally allow for easier sealing of the module to the controller frame.

COM modules are advantageous due to their small size and large computing density; however, the present invention contemplates using other suitable small-sized and dense processors, such as Embedded technology eXtended (ETX) specification modules or modules designed specifically for the controller of the present invention.

As shown in the illustrated exemplary embodiment of FIG. 6, the RAM storage controller, the digital signal processor, the onboard processor, and the FPGA can be connected via a PCI Bus. These elements of the controller frame 100 can then be connected to a network multi-port interface or PHY. The modular components 310 330, 340 that are plugged into the recesses R of the control frame 100 can also be connected to the network via the interface or PHY. As illustrated in FIG. 5, the modular components can include an additional modular processor with a graphics processor, a radio module, and a third processor and/or storage, for example for data that must be segregated such as classified data.

Certain embodiments of the present teachings contemplate using the FPGA to perform the functionality of the digital signal processor. Certain embodiments also contemplate additional storage within the controller frame 100 that is connected to the digital signal processor, onboard processor, and FPGA via the network.

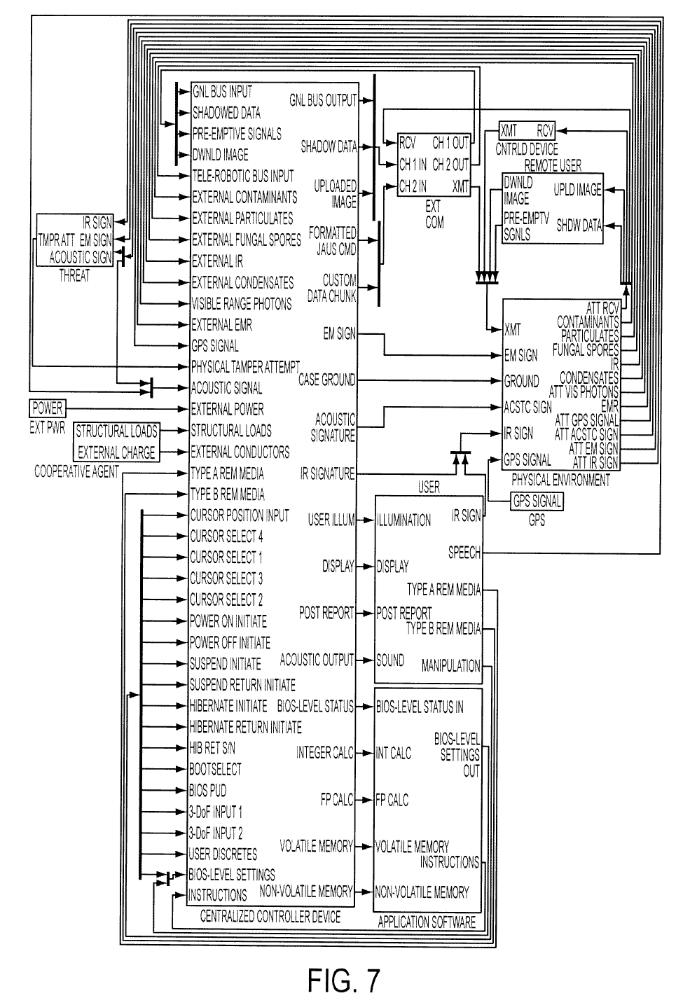

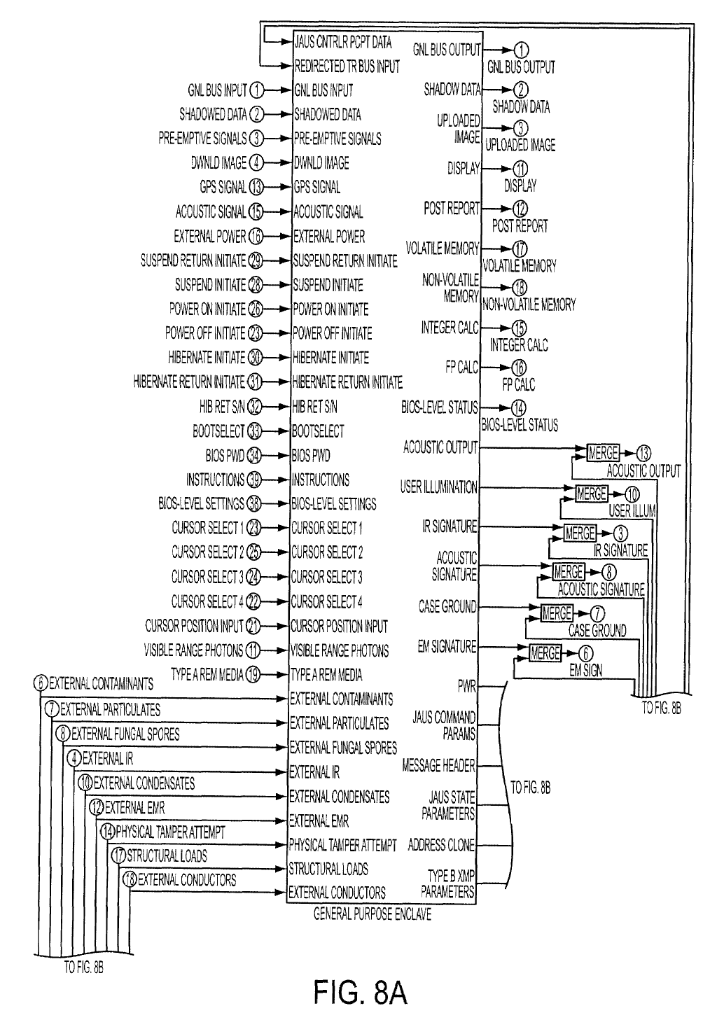

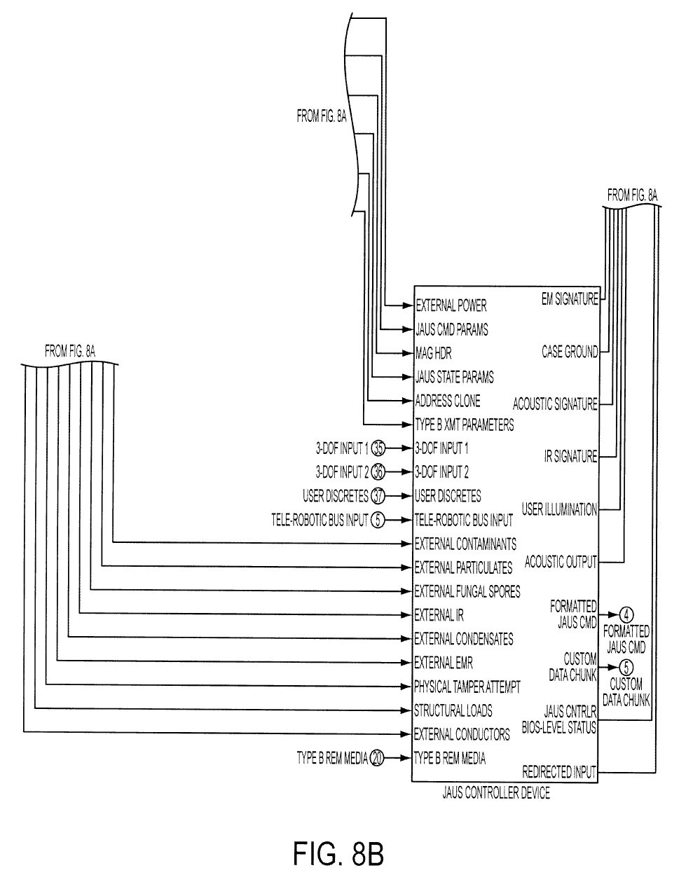

FIG. 7 illustrates an exemplary embodiment of external interactions that the onboard processor can have in accordance with the present teachings. The illustrated interactions are generally limited to basic system functionality and interactions that are not likely to be changed during upgrades and reconfigurations. Examples of such functionality may include remote vehicle teleoperation, radio interface, non-volatile storage, platform sensor I/O, actuator controls, real-time kinematics for the vehicle, acoustics interface, acoustic direction finder, and/or video compression and decompression. FIG. 8 illustrates an exemplary embodiment of internal interactions that the onboard processor can have in accordance with the present teachings, which similarly are generally limited to basic system functionality and interactions that are not likely to be changed during upgrades and reconfigurations.

While the present invention has been disclosed in terms of preferred embodiments in order to facilitate better understanding of the invention, it should be appreciated that the invention can be embodied in various ways without departing from the principle of the invention. Therefore, the invention should be understood to include all possible embodiments which can be embodied without departing from the principle of the invention set out in the appended claims.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. Thus, for example, reference to a module can include two or more different modules. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the sample preparation device and method of the present disclosure without departing from the scope its teachings. Other embodiments of the disclosure will be apparent to those skilled in the art from consideration of the specification and practice of the teachings disclosed herein. It is intended that the specification and examples be considered as exemplary only.

What is claimed is:

1. A portable network for connecting and utilizing functional modules to create an upgradable and reconfigurable device for controlling a remote vehicle, the portable network connecting a processor configured to control a remote vehicle with recesses configured to receive functional modules.

2. The portable network of claim 1, wherein the functional modules comprise one or more of a radio module, a processor module, and storage module.

3. The portable network of claim 1, wherein the network is a gigabit Ethernet.

4. The portable network of claim 1, further comprising a power source.

5. The portable network of claim 4, wherein the power source is a swappable battery.

6. The portable network of claim 1, further comprising a communication device for exchanging data between the portable network and the remote vehicle.

7. The portable network of claim 6, wherein the communication device comprises one or more of a radio module and a tether.

8. A portable modular system comprising:
a frame including a processor, a network backplane, a display, one or more input devices, and recesses configured to receive functional modules,
wherein a communication device is included in the frame or connectable to the frame, and
wherein the network backplane connects the processor and the functional modules, allowing at least one of the processor and the functional modules to control a remote vehicle via the display, the input devices, and the communication device.

9. The portable modular system of claim 8, wherein the network is a gigabit Ethernet.

10. The portable modular system of claim 8, configured to perform certain functions and able to perform one or more of the certain functions despite other of the certain functions being unavailable.

11. The portable modular system of claim 10, wherein the other of the certain functions are unavailable because a functional module is in hibernate mode to save battery power, removed, or turned off purposefully.

12. The portable modular system of claim 8, configured to only allow control of a remote vehicle for training, repair, testing, or maintenance.

13. The portable modular system of claim 8, comprising system-level power management configured to awaken processors only as their functionality is needed.

14. A portable device for controlling a remote vehicle, the device comprising:
input devices configured to allow the user to input controls for the remote vehicle;
a display configured to display data regarding the remote vehicle to the user;
a communication device for exchanging data between the user and the remote vehicle;
an onboard processor configured for controlling the remote vehicle;
a network backplane; and
recesses configured to receive functional modules that allow upgrading and reconfiguring of the device, functional modules inserted into the recesses being connected to at least one other element of the frame via the network backplane.

15. The portable device of claim 14, configured to perform one or more of the following additional functions: operator training and simulations; unattended munitions control; logistics and maintenance control, tracking, and assistance; control and monitoring of unmanned ground sensors; mission rehearsal and preparations/planning; and medical diagnostics.

16. The portable device of claim 14, wherein the onboard processor is also configured to perform video compression/decompression, protocol handling, and graphics processing and display.

17. The portable device of claim 14, further comprising a digital signal processor and an FPGA, the digital signal processor and the FPGA being connected to the onboard processor to provide graphics processing for output to the display.

18. The portable device of claim 17, further comprising a processor module including a graphics processor.

19. The portable device of claim 18, wherein the processor module can be mapped to control the display.

20. The portable device of claim 19, configured to allow reduced latency using the digital signal processor and the FPGA logic to map into a picture-in-picture window on the display that can receive video streams without having to pass through the processor module.
